(19) United States
(12) Patent Application Publication
(10) Pub. No.: US 2020/0226392 A1
(43) Pub. Date: Jul. 16, 2020

(54) COMPUTER VISION-BASED THIN OBJECT DETECTION

(71) Applicant: MICROSOFT TECHNOLOGY LICENSING, LLC, Redmond, WA (US)

(72) Inventors: Gang HUA, Redmond, WA (US); Jiaolong YANG, Redmond, WA (US); Chunshui ZHAO, Redmond, WA (US); Chen ZHOU, Redmond, WA (US)

(73) Assignee: MICROSOFT TECHNOLOGY LICENSING, LLC, Redmond, WA (US)

(21) Appl. No.: 16/631,935

(22) PCT Filed: May 23, 2018
(86) PCT No.: PCT/US2018/034813

§ 371 Date: Jan. 17, 2020

(30) Foreign Application Priority Data
Jul. 20, 2017 (CN) 201710597328.X

(51) Int. Cl. G06K 9/00; G06K 9/46; H04N 13/271

(52) U.S. Cl. CPC G06K 9/00805; G06K 9/4609; H04N 2013/0085; H04N 13/271; G06K 9/00664; G06K 9/00208

(57) ABSTRACT

Implementations of the subject matter described herein provide a solution for thin object detection based on computer vision technology. In the solution, a plurality of images containing at least one thin object to be detected are obtained. A plurality of edges are extracted from the plurality of images, and respective depths of the plurality of edges are determined. In addition, the at least one thin object contained in the plurality of images is identified based on the respective depths of the plurality of edges, the identified at least one thin object being represented by at least one of the plurality of edges. The at least one thin object is an object with a significantly small ratio of cross-sectional area to length. It is usually difficult to detect such thin object with a conventional detection solution, but the implementations of the present disclosure effectively solve this problem.

### FIELD

Safety is paramount for mobile robotic platforms such as self-driving cars and unmanned aerial vehicles. To perform obstacle detection and collision avoidance, some conventional solutions utilize active sensors to measure distances between a platform and surrounding objects. The active sensors include, for example, radar, sonar, and various types of depth cameras. However, thin-structure obstacles such as wires, cables and tree branches can be easily missed by these active sensors due to limited measuring resolution, thus raising safety issues. Some other conventional solutions perform obstacle detection based on images captured by, for example, a stereo camera. The stereo camera can provide images with high spatial resolution, but thin obstacles still can be easily missed during stereo matching due to their extremely small coverage and the background clutter in the images.

### SUMMARY

According to implementations of the subject matter described herein, there is provided a solution for thin object detection based on computer vision technology. In the solution, a plurality of images containing at least one thin object to be detected are captured by a moving monocular or stereo camera. The at least one thin object in the plurality of images is identified by detecting a plurality of edges in the plurality of images and performing three-dimensional reconstruction on the plurality of edges. The identified at least one thin object may be represented by at least some of the plurality of edges. The solution of the subject matter described herein can efficiently implement thin obstacle detection using limited computing resources.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a block diagram of a computing device in which implementations of the subject matter described herein can be implemented;

FIG. 2 illustrates a block diagram of a system for thin object detection based on a monocular camera according to an implementation of the subject matter described herein;

FIG. 3 illustrates an exemplary representation of a depth map according to an implementation of the subject matter described herein;

FIG. 4 illustrates a block diagram of a system for thin object detection based on a stereo camera according to an implementation of the subject matter described herein;

FIG. 5 illustrates a flow chart of a process of detecting a thin object according to an implementation of the subject matter described herein.

In all figures, the same or like reference numbers denote the same or like elements.

### DETAILED DESCRIPTION

The subject matter described herein will now be discussed with reference to several example implementations. It is to be understood these implementations are discussed only for the purpose of enabling those skilled persons in the art to better understand and thus implement the subject matter described herein, rather than suggesting any limitations on the scope of the subject matter.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. The following text may also contain other explicit or implicit definitions.

### Problem Overview

In a current conventional obstacle detection system, detection for a thin object is usually not noticed. As used herein, a “thin object” usually refers to an object with a relatively small ratio of cross-sectional area to length. For example, the thin object may be an object whose cross-sectional area is less than a first threshold and whose length is greater than a second threshold, where the first threshold may be 0.2 square centimeters and the second threshold may be 5 centimeters. The thin object may have a shape similar to a column, for example, but not limited to a cylinder, a prism and a thin sheet. Examples of the thin object may include but not limited to thin wires, cables and tree branches.

However, thin object detection is paramount for mobile robotic platforms such as self-driving cars and unmanned aerial vehicles. For example, in unmanned aerial vehicle application, collision with cables, branches or the like has become a main cause for unmanned aerial vehicle accidents. In addition, detection of thin objects can significantly enhance the safety for self-driving cars or indoor robots. It is difficult for the existing conventional obstacle detection systems to detect thin objects. As mentioned above, due to various characteristics of the thin objects themselves, the thin objects usually cannot be easily detected by those solutions which detect obstacles based on active sensors or based on image regions.

The inventor recognizes through research that three goals regarding thin object detection need to be achieved: (1) sufficiently complete edge extraction: edges of a thin object should be extracted and be complete enough that the thin object will not missed; (2) sufficiently accurate depth recovery: three-dimensional coordinates of the edges should be recovered and be accurate enough that subsequent actions, such as collision avoidance, can be performed safely; (3) sufficiently high execution efficiency: the algorithm needs to be efficient enough to be implemented in an embedded system with limited computing resources for performing real-time obstacle detection.

The second and third goals among the three goals might be common for conventional obstacle detection systems, while the first goal is usually difficult to be achieved in the conventional obstacle detection solutions. For example, for a classical region-based obstacle detection system targeting at regularly shaped objects, missing some part of an object will probably be acceptable, as long as some margin around the object is reserved. However, complete edge extraction is of great importance for thin object detection. For example, in some cases, an obstacle such as a thin wire or cable might across the whole image. If a part of the thin wire or cable is missed during detection, occurrence of collision might be caused.

Basic principles and several exemplary implementations of the subject matter described herein will be described in detail below with reference to figures.

### Example Environment

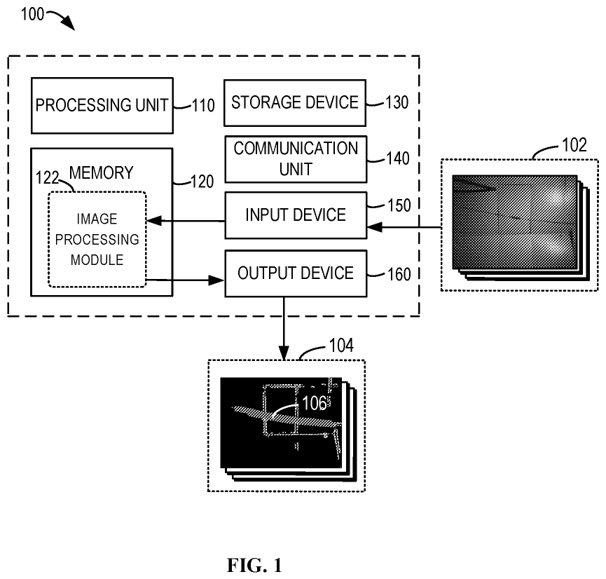

FIG. 1 illustrates a block diagram of a computing device 100 in which implementations of the subject matter described herein can be implemented. It would be appreciated that the computing device 100 described in FIG. 1 is merely exemplary, without suggesting any limitations to the function and scope of implementations of the subject matter described herein in any manners. As shown in FIG. 1, the computing device 100 comprises a computing device 100 in the form of a general computing device. Components of the computing device 100 may include, but are not limited to, one or more processors or processing units 110, a memory 120, a storage device 130, one or more communication unit(s) 140, one or more input device(s) 150, and one or more output device(s) 160.

In some implementations, the computing device 100 may be implemented as various user terminals or service terminals with computing capabilities. The service terminals may be servers, large-scale computing devices provided by various service providers. The user terminals are for example any type of mobile terminals, fixed terminals, or portable terminals, including a self-driving car, an aircraft, a robot, a mobile phone, multimedia computer, multimedia tablet, Internet node, communicator, desktop computer, laptop computer, tablet computer, personal communication system (PCS) device, personal navigation device, personal digital assistant (PDA), digital camera/video camera, positioning device, playing device or any combination thereof, including the accessories and peripherals of these devices, or any combination thereof

The processing unit 110 may be a physical or virtual processor and perform various processes based on programs stored in the memory 120. In a multi-processor system, a plurality of processing units execute computer-executable instructions in parallel to improve parallel processing capacity of the computing device 100. The processing unit 110 can also be referred to as a Central Processing Unit (CPU), a microprocessor, a controller, or a microcontroller.

The computing device 100 typically includes various computer storage media. Such media can be any media accessible by the computing device 100, including but not limited to volatile and non-volatile media, or removable and non-removable media. The memory 120 can be a volatile memory (for example, a register, cache, Random Access Memory (RAM)), non-volatile memory (for example, a Read-Only Memory (ROM), Electrically Erasable Programmable Read-Only Memory (EEPROM), flash memory), or any combination thereof. The memory 120 includes an image processing module 122. These program modules are configured to perform functions of various implementations described herein. The image processing module 122 may be accessed and executed by the processing unit 110 to perform corresponding functions.

The storage device 130 can be any removable or non-removable media and may include machine-readable media, which can be used for storing information and/or data and accessed within the computing device 100. The computing device 100 may further include additional removable/non-removable or volatile/non-volatile storage media. Although not shown in FIG. 1, a disk drive is provided for reading and writing from/to a removable and non-volatile disk and a disc drive is provided for reading and writing from/to a removable non-volatile disc. In such case, each drive is connected to the bus (not shown) via one or more data media interfaces.

The communication unit 140 communicates with a further computing device via communication media. Additionally, functions of components in the computing device 100 can be implemented in a single computing cluster or a plurality of computing machines that are communicated with each other via communication connections. Therefore, the computing device 100 can be operated in a networking environment using a logical connection to one or more other servers, network personal computers (PCs), or another general network node.

The computing device 100 may further communicate with one or more external devices (not shown) such as a storage device or a display device, one or more devices that enable users to interact with the computing device 100, or any devices that enable the computing device 100 to communicate with one or more other computing devices (for example, a network card, modem, and the like). Such communication can be performed via input/output (I/O) interfaces (not shown).

The input device 150 can include one or more input devices such as a mouse, keyboard, tracking ball, voice input device, and the like. The output device 160 can include one or more output devices such as a display, loudspeaker, printer, and the like. The computing device 100 may further, via the communication unit 140, communicate with one or more external devices (not shown) such as a storage device, a display device and the like, one or more devices that enable users to interact with the computing device 100, or any devices that enable the computing device 100 to communicate with one or more other computing devices (for example, a network card, modem, and the like). Such communication can be performed via input/output (I/O) interfaces (not shown).

The computing device 100 may be used to implement object detection in implementations of the subject matter described herein. Upon performing object detection, the input device 150 may receive one or more images 102 captured by a moving camera, and provide them as input to the image processing module 122 in the memory 120. The images 102 are processed by the image processing module 122 to detect one or more objects appearing therein. A detection result 104 is provided to the input device 160. In some examples, the detection result 104 is represented as one or more images with the detected object indicated by a bold line. In the example as shown in FIG. 1, the bold line 106 is used to indicate a cable appearing in the image. It is to be understood that the image sequence 102 and 104 are presented only for the purpose of illustration and not intended to limit the scope of the subject matter described herein.

It is noted that although the image processing module 122 in FIG. 1 is shown as a software module uploaded to the memory 120 upon execution, but this is only exemplary. In other implementations, at least a part of the image processing module 122 may be implemented by virtue of hardware means such as a dedicated integrated circuit, a chip or other hardware modules.

### System Architecture and Working Principle

As mentioned above, to implement thin object detection, the following goals need to be achieved: (1) sufficiently complete edge extraction; (2) sufficiently accurate depth restoration; and (3) sufficiently high execution efficiency.

To solve the above problems and one or more of other potential problems, according to example implementations of the subject matter described herein, there is provided a solution of thin object detection based on computer vision technology. The solution represent an object with edges in a video frame, for example, edges are comprised of image pixels which present a large gradient. In the solution, a moving monocular or stereo camera is used to capture video about surrounding objects. The captured video may include a plurality of images. According to the solution, the thin object contained in the plurality of images is detected by detecting a plurality of edges in the plurality of images and performing three-dimensional reconstruction on the plurality of edges. The thin object may be represented by at least some of the plurality of edges.

The solution of object detection based on edges in the images can achieve benefits in two aspects. First, it is difficult to detect thin objects such as thin wires, cables or tree branches based on image regions or image blocks due to their extremely small coverage in the image. On the contrary, these objects can be detected by a proper edge detector more easily. Second, since edges in the image retain important structural information of the scenario described by the image, detecting objects based on the edges in the image can achieve relatively high computing efficiency. This is of great importance for an embedded system. Therefore, the solution of the subject matter described herein can efficiently implement thin obstacle detection using limited computing resources, and can be implemented in the embedded system to perform real-time obstacle detection.

Since the solution of the subject matter described herein realizes detection of an object by three-dimensional reconstruction of edges of the object, the solution of the subject matter described herein can also be used to detect a general object with texture edges in addition to being able to detect a thin object. In addition, in conjunction with active sensors adapted to detect a relatively large object without obvious textures or transparent object, the detection according to implementations of the subject matter described herein can reliably and robustly achieve detection of various types of objects. It is to be understood that although implementations of the subject matter described herein are illustrated with respect to thin object detection in the depictions in the text here, the scope of the subject matter described herein is not limited in this aspect.

In the following, a pixel located on edges in the image are called edge pixels. For example, the edge pixels may be image pixels that present a large gradient. An edge pixel may be represented as a tuple e={p, g, d, σ}, wherein p represents coordinates of the edge pixel in the image and g represents a gradient associated with the edge pixel. d reflects a depth of the edge pixel, and σ reflects a variance of the depth. In some examples, to facilitate computing, d may be equal to a reciprocal (also called “reverse depth”) of the depth of the edge pixel, and σ may be equal to a variance of the reverse depth. However, it is to be understood that it is only for the purpose of easy computation and not intended to limit the scope of the subject matter described herein. In some other examples, d and σ may also be represented in other forms. Assume that the images captured by the moving camera includes two continuous frames, movement of the camera corresponding to the two continuous frames may be represented as a six-dimensional vector ξ={w, v}. Specifically, w represents the rotation of the camera, where wϵso(3) and so(3) represents a three-dimensional rotation group. v represents the translation of the camera, and v [symbol] ³, namely v belongs to a three-dimensional Euclidean space. R=exp(w)(Rϵso(3)) represents a rotation matrix. Specially, assume that the coordinate of a 3D point in a first frame is pc, the corresponding coordinate of the 3D point in the second frame p_{c}=Rp_{c}+v. The 6-dimensional vector ξ={w, v} may be used as a representation of an Euclidean transformation, where ξϵse(3) and se(3) represents a Euclidean movement group.

Some example implementations of the solution of thin object detection based on a monocular camera and the solution of thin object detection based on a stereo camera will be separately described below in conjunction with the drawings.

Thin Object Detection based on a Monocular Camera

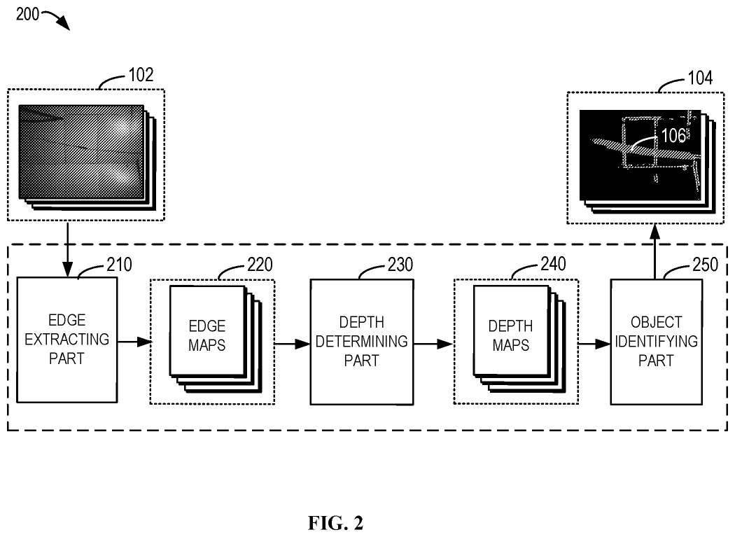

FIG. 2 illustrates a block diagram of a system 200 for thin object detection based on a monocular camera according to an implementation of the subject matter described herein. In some implementations, the system 200 may be implemented as at least a part of the image processing module 122 of the computing device 100 of FIG. 1, namely, implemented as a computer program module. Alternatively, in other implementations, the system 200 may also be partially or fully implemented by a hardware device.

As shown in FIG. 2, the system 200 may include an edge extracting part 210, a depth determining part 230 and an object identifying part 250. In the implementation as shown in FIG. 2, a plurality of input images obtained by the system 200 are a plurality of continuous frames in a video captured by a moving monocular camera. For example, the plurality of input images 102 involve a thin object to be detected, such as a cable or the like. In some implementations, the input images 102 may be of any size and/or format.

### Edge Extraction

In some implementations of the subject matter described herein, it is expected that the thin object contained in the input images 102 can be detected. In the example as shown in FIG. 2, the edge extracting part 210 may extract a plurality of edges included in the plurality of input images 102. In some implementations, the edge extracting part 210 may extract a plurality of edges included in the plurality of input images 102 based on DoG technology and Canny edge detection algorithm.

The principle of the DoG technology according to implementations of the subject matter described herein is to use Gaussian kernels with different standard deviations to convolve with an original image so as to derive different Gaussian vague images. By determining the difference among the different Gaussian blurred images, the likelihood of each pixel in the original image belonging to an edge pixel can be determined. In some implementations, the edge extracting part 210 may determine, based on the DoG technology, a likelihood that each of pixels in each of the input images 102 belongs to an edge pixel. For example, the likelihood may be indicated by a score associated with the pixel.

In some implementations, the edge extracting part 210 may determine whether each of pixels in the input image 102 belongs to the plurality of edges based on the determined score associated with the pixel and using, at least in part, the Canny edge detection technology. Specifically, the Canny edge detection technology provides a dual threshold judgment mechanism. The dual thresholds include both a higher threshold and a lower threshold for determining whether the pixel belongs to an edge pixel. If the score of the pixel is less than the lower threshold, the pixel may be determined not to be an edge pixel. If the score of the pixel is greater than the higher threshold, the pixel may be determined to belong to an edge pixel (the pixel may be called a “strong edge pixel”). If the score of the pixel is between the lower threshold and the higher threshold, the edge extracting part 210 may further determine whether there is a strong edge pixel near the pixel. When there is a strong edge pixel near the pixel, the pixel may also be considered as being connected with the strong edge pixel, and therefore also belong to the edge pixel. Otherwise, the pixel is determined to be a non-edge pixel.

The advantages of extracting the plurality of edges based on the DoG technology and Canny edge detection algorithm lie in that the DoG technology provides good regression precision and can stably determine the likelihood that each of the pixels belongs to an edge pixel. The Canny edge detection technology can reduce the number of false edges, and improve the detection rate of non-obvious edges. In this way, the edge extracting part 210 can effectively extract the plurality of edges included in the plurality of input images 102.

It is to be understood that the edge extracting part 210 may also extract edges using any edge detection technology currently known or to be developed, including but not limited to a gradient analysis method, a differential operator method, a template matching method, a wavelet detection method, a neural network method or combinations thereof The scope of the subject matter described herein is not limited in this aspect.

In some implementations, the edge extracting part 210 may represent the extracted plurality of edges in a plurality of edge maps 220 corresponding to the plurality of input images 102. For example, each of the edge maps 220 may identify edge pixels in a respective input image 102. In some implementations, an edge map 220 may be a binary image. For example, each pixel value in the edge map 220 may be ‘0’ or ‘1’, where ‘0’ indicates that the pixel in the respective input image 102 corresponding to the pixel value is a non-edge pixel, while ‘1’ indicates that the pixel in the respective input image 102 corresponding to the pixel value is an edge pixel.

Edge 3D Reconstruction based on VO Technology

The plurality of edge maps 220 generate by the edge extracting part 210 may be provided to the depth determining part 230. In some implementations, the depth determining part 230 may reconstruct the extracted plurality of edges in a 3D space by determining depths of the extracted plurality of edges. In some implementations, the depth determining part 230 may use for example Visual Odometry (VO) technology to perform 3D reconstruction of the plurality of edges, where the depth of each edge pixel is represented as a Gaussian distribution (namely, mean and variance of depth values). For example, the depth determining part 230 may perform 3D reconstruction of the plurality of edges through a tracking step and a mapping step, where the tracking step may be used to determine movement of the camera, while the mapping step may be used to generate a plurality of depth maps 240 respectively corresponding to the plurality of edge maps 220 and indicating respective depths of the plurality of edges. The two steps will be further described below in more detail.

As stated above, the input images 102 are a plurality of continuous frames in the video captured by the monocular camera. Without loss of generality, assume that the plurality of continuous frames include two adjacent frames, called “a first frame” and “a second frame”. The plurality of edge maps 220 generated by the edge extracting part 210 may include a respective edge map (called a “first edge map” herein) corresponding to the first frame and a respective edge map (called a “second edge map” herein) corresponding to the second frame. In some implementations, the movement of the camera corresponding to the change from the first frame to the second frame may be determined by fitting from the first edge map to the second edge map. Ideally, the edge pixels in the first frame indicated by the first edge map are projected on the corresponding edge pixels in the second frame via the movement of the camera. Therefore, the depth determining part 230 may an objective function for measuring the projection error based on the first and second edge maps, and determine the movement of the camera corresponding to the change from the first frame to the second frame by minimizing the projection error.

For example, in some implementations of the subject matter described herein, an example of the objective function may be represented as follows:

Eₒ(w, v)=ρ((W(pᵢ, dᵢ, ξ)−p̅ᵢ)·g̅ᵢ) (1)

where ξ={w, v} represents the movement of the camera corresponding to the change from the first frame to the second frame, and it is a 6-dimensional vector to be determined. Specifically, w represents the rotation of the camera corresponding to the change from the first frame to the second frame. v represents the translation of the camera corresponding to the change from the first frame to the second frame. W represents a warping function for projecting the i^{th} edge pixel pi in the first frame into the second frame. dᵢ represents a depth of the edge pixel pᵢ. p̅ᵢ represents an edge pixel in the second frame corresponding to the edge pixel pᵢ, and it may be derived by searching for the second edge map in a gradient direction of the edge pixel pᵢ. g̅ᵢ represents the gradient direction of the edge pixel p̅ᵢ. ρ represents a predefined penalty function for the projection error.

In some implementations, the depth determining part 230 may determine the movement (namely, w and v) of the camera corresponding to the change from the first frame to the second frame by minimizing the above equation (1). For example, the minimization may be implemented by using Levenberg-Marquardt (L-M) algorithm, where an initial point of the algorithm may be determined based on an assumed constant value.

The monocular camera usually cannot provide exact scale information. In some implementations, for example, the scale ambiguity for the monocular camera may be solved by providing information on the initial absolute position of the camera to the depth determining part 230. Additionally or alternatively, in some other implementations, the scale ambiguity for the monocular camera may be solved by introducing inertia measurement data associated with the camera. For example, the depth determining part 230 may obtain the inertia measurement data associated with the camera from an inertia measurement unit mounted, together with the camera, on the same hardware platform (e.g., unmanned aerial vehicle or mobile robot).

In some implementations, the inertia measurement data from the inertia measurement unit may provide initialization information on the movement of the camera. Additionally or alternatively, in some other embodiments, the inertia measurement data may be used to add a penalty item to the above equation (1) for penalizing a deviation away from the minimization objective.

For example, an example objective function according to some other implementations of the subject matter described herein may be represented as:

E(w, v)=E₀(w, v)+λ_{w} ∥w−w₀∥²+λᵥ∥v−v_{0∥}² (2)

where E₀(w, v) represents the original geometry error calculated according to the equation (1), and the two quadratic terms are priors to regularize the final solution closer to (w₀, v₀). (w₀, v₀) represents the movement of the camera obtained from the inertia measurement data corresponding to the change from the first frame to the second frame, where wo represents the translation of the camera and v₀ represents the translation of the camera. λ_{w} and λᵥ represent respective weights of the two quadratic terms in the objective function and may be predefined constants.

In some implementations, the depth determining part 230 may determine the movement (namely, w and v) of the camera corresponding to the change from the first frame to the second frame by minimizing the above equation (2). For example, the minimization may be implemented by using the L-M algorithm, where (w₀, v₀) may be used as an initial point of the algorithm.

Once the movement of the camera is determined, the depth determining part 230 may generate, by the mapping step, the plurality of depth maps 240 corresponding to the plurality of edge maps 220 and indicating respective depths of the plurality of edges. In some implementations, the depth determining part 230 may use epipolar search technology to perform edge matching for the second edge map and the first edge map. For example, the depth determining part 230 may match the edge pixels in the second frame with those in the first frame through the epipolar search. For example, criterions for the edge matching may be determined based on the gradient direction and/or the movement of the camera determined above. The result of the epipolar search may be used to generate the plurality of depth maps 240.

Without loss of generality, assume that a depth map (called a “first depth map” herein) corresponding to the first edge map has been already determined (e.g., the depth map of the initial frame may be determined based on an assumed constant value). In some implementations, the depth determining part 230 may generate a depth map (called a “second depth map” herein) corresponding to the second edge map based on the first depth map, the determined movement of the camera corresponding to the change from the first frame to the second frame, and the result of the epipolar search. For example, the depth determining part 230 may estimate the second depth map based on the first depth map and the determined movement of the camera (the estimated second depth map is also called an “intermediate depth map” herein). Further, the depth determining part 230 may use the result of the epipolar search to correct the intermediate depth map so as to generate the final second depth map. For example, the above process of generating the second depth map can be implemented by using extended Kalman filter (EKF) algorithm, where the process of using the result of the epipolar search to correct the estimated second depth map is also called a process of data fusion. During execution of the EKF algorithm, the result of the epipolar search may be considered as observation variables to correct the intermediate depth map.

Due to aperture problem and lack of an effective match descriptor, the edge matching based on the epipolar search may be usually difficult. When the initial camera movement and/or depth estimation are inaccurate, wrong matching is very common. Moreover, it is possible that there are a plurality of similar edges in the search range. To solve the above problem, in some implementations, upon searching the first edge map for an edge pixel matching a corresponding edge pixel in the second frame, the depth determining part 230 may first determine all candidate edge pixels satisfying the edge matching criterions (as stated above, the edge matching criterions may be determined based on the gradient direction and/or the determined camera movement), and then calculate their position variance along the epipolar line.

If the number of the candidate edge pixels is relatively small, the position variance is usually small, indicating a definite match. If the number of the candidate edge pixels is relatively large, the position variance is usually large, indicating an indefinite match. The position variance may decide an impact of the candidate edge pixels on the correction of the intermediate depth map. For example, a smaller position variance may decide that the candidate edge pixels have a larger impact on the above data fusion process, while a larger position variance may decide that the candidate edge pixels have a smaller impact on the above data fusion process. In this way, the implementations of the subject matter described herein can effectively improve effectiveness of edge matching.

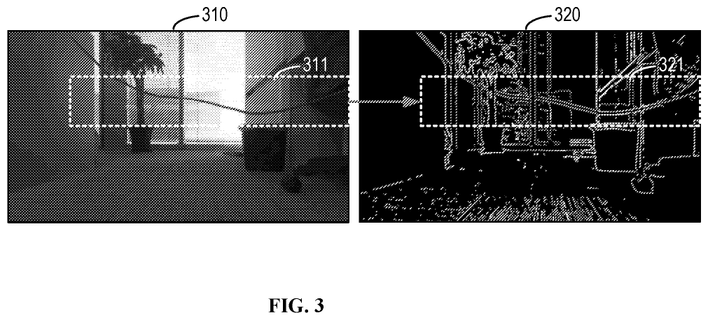

In some implementations, the depth determining part 230 may represent each of the generated plurality of depth maps 240 as an image with different colors. The depth determining part 230 may use different colors to represent different depths of edge pixels. For example, an edge pixel corresponding to an edge far away from the camera may be represented with a cold color, while an edge pixel corresponding to an edge close to the camera may be represented with warm colors. For example, FIG. 3 illustrates an exemplary representation of a depth map according to an implementation of the subject matter described herein. In this example, an image 310 may be a frame in the input images 102, and a depth map 320 is a depth map corresponding to the image 310 generated by the depth determining part 230. As shown in FIG. 3, a section of cable is indicated by a dashed box 311 in the image 310, and depths of the edge pixels corresponding to the section of cable are indicated by a dashed box 321 in the depth map 320.

### Object Identification

The plurality of depth maps 240 generated by the depth determining part 230 are provided to the object identifying part 250 In some implementations, the object identifying part 250 may identify at least one edge belonging to the thin object based on the plurality of depth maps 240. Ideally, edge pixels falling within a predefined 3D volume S may be identified as belonging to the thin object, where the predefined 3D volume S may be a predefined spatial scope for detecting the thin object. However, the original depth maps usually has noises. Therefore, in some implementations, the object identifying part 250 may identify edge pixels with stable depth estimations and matched across a plurality of frames as belonging to the thin object to be recognized. Specifically, for each edge pixel eᵢ, in addition to its image position pᵢ and depth dᵢ, the object identifying part 250 may also consider its variance σ, and the number tᵢ of frames it has been successfully matched as a criterion for identifying the thin object (for example, the variance σᵢ should be less than a threshold σₜₕ and the number tᵢ of frames it has been successfully matched should be greater than a threshold tₜₕ).

In some implementations, considering that noisy edges are usually scattered in the depth map, the object identifying part 250 may perform a filtering step on edge combinations that have been identified as belonging to the thin object. In the following, an “edge belonging to the thin object” is called an “object edge”; and an “edge pixel belonging to the thin object” is also called an “object pixel”. For the sake of the execution efficiency, the filtering process for example may not be executed if the number of initially identified object edges is below a threshold cntₗ or exceeds a threshold cntₕ, where the number of object edges below the threshold cntₗ indicates unlikely existence of any thin object in the image, while the number of object edges exceeding the threshold cntₕ indicates highly likely existence of a thin object in the image.

In some implementations, the filtering process may filter out edge combinations belonging to noises in the object edges that have been identified. The edge combination belonging to noises may be a combination of some object edges of small size. For example, two object pixels with a distance smaller than a threshold nₜ (pixels) may be defined as being connected to each other, namely, belong to the same object edge combination. In some implementations, a size of the object edge combination may be determined based on the number of object pixels in the object edge combination. For example, when the size of the object edge combination is smaller than a certain threshold, the object edge combination may be considered as belonging to noises.

Additionally or alternatively, considering the execution efficiency, the filtering process may be implemented by searching for the connected object edge combination on a corresponding image Iᵣ obtained by scaling each of the depth maps 240 by a scaling factor with a magnitude of nₜ. For example, a value of each of pixels in the image Iᵣ may be equal to the number of object pixels in a corresponding nₜ×nₜ block of the original depth map. Therefore, the size of the corresponding object edge combination in the original image may be determined by summing values of connected pixels in the image Iᵣ.

The following Table 1 shows an example of program pseudocode for the above process of identifying the thin object, where the above-described filtering process of filtering edge combinations belonging to noises in the object edges that have been identified is represented as a function FILTER(). π represents a projection function that projects a point in the coordinate system of the camera into the image coordinate system, and π⁻¹ represents an inverse function of π.

```
TABLE 1
Algorithm of Identifying Edge Pixels Belonging to Thin Object
Input: List of edge pixels, where each of the edge pixels eᵢ = {pᵢ,dᵢ,σᵢ,tᵢ}
Thresholds: σₜₕ [symbol]   tₜₕ [symbol]   cntₗ [symbol]   cntₕ and S
Output: List of edges pixels belonging to the thin object O
Variable: cnt←0
for each edge pixel eᵢ do
  if σᵢ<σₜₕ and tₜₕ<tᵢ and π⁻¹(pᵢ, dᵢ) ϵ S then
    oᵢ = true // the i^{th} edge pixel is identified as blonging to the thin
object
    cnt←cnt+1
if cnt ϵ[cntₗ, cntₕ] then
  O←FILTER(O)
return O
```

Based on the identified edges belonging to the thin object, the object identifying part 250 may output a detection result 104. In some examples, the detection result 104 may be represented as a plurality of output images with the detected object indicated by a bold line. For example, the plurality of output images 104 may have the same size and/or format as the plurality of input images 102. As shown in FIG. 2, the bold line 106 is used to indicate the identified thin object.

The above illustrates the solution of thin object detection based on the monocular camera according to some implementations of the subject matter described herein. The solution of thin object detection based on a stereo camera according to some implementations of the subject matter described herein will be described below in conjunction with the drawings.

Thin Object Detection based on a Stereo Camera

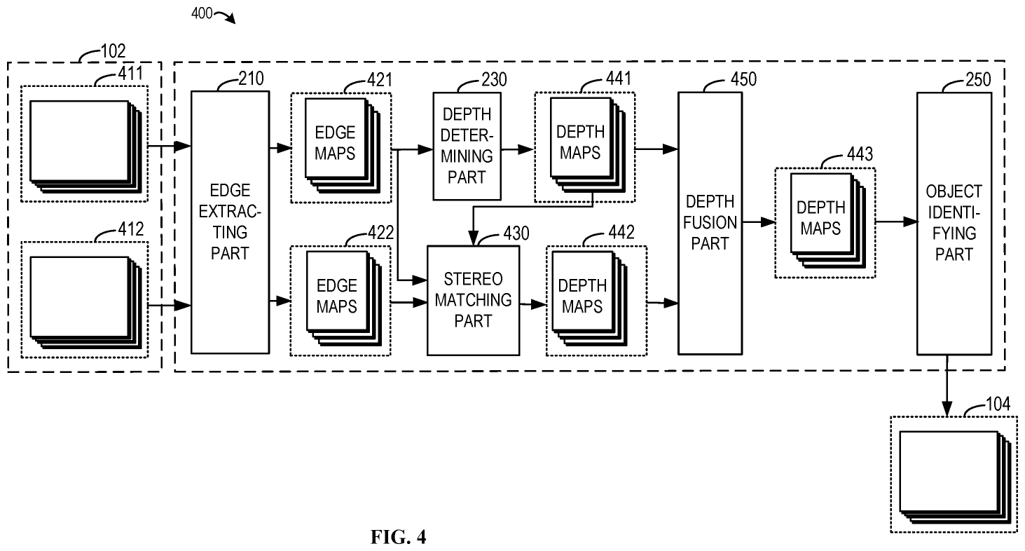

FIG. 4 illustrates a block diagram of a system 400 for thin object detection based on a stereo camera according to an implementation of the subject matter described herein. The system 400 may be implemented at the image processing module 122 of the computing device 100 of FIG. 1. As shown in FIG. 4, the system 400 may include an edge extracting part 210, a depth determining part 230, a stereo matching part 430, a depth fusion part 450 and an object identifying part 250.

In the example of FIG. 4, a plurality of input images 102 obtained by the system 400 are a plurality of continuous frames in a video captured by a moving stereo camera. The stereo camera capturing the plurality of input images 102 may include at least a first camera (e.g., a left camera) and a second camera (e.g., a right camera). The “stereo camera” as used herein may be considered as a calibrated stereo camera. That is, X-Y planes of the first and second cameras are coplanar and the X axes of both cameras are both coincident with the line (also called “a baseline”) connecting optical centers of the two cameras, such that the first and second cameras only have translation in X-axis direction in a 3D space. For example, the plurality of input images 102 may include a first set of images 411 captured by the first camera and a second set of images 412 captured by the second camera. In some implementations, the first set of images 411 and the second set of images 412 may have any size and/or format. Specially, the first set of image 411 and the second set of images 412 may be images relating to the same thin object (e.g., cable) to be detected. According to the implementations of the subject matter described herein, it is desirable to detect the thin object contained in the input images 102.

### Edge Extraction

In the example as shown in FIG. 4, the edge extracting part 210 may extract a plurality of edges included in the first set of images 411 and the second set of images 412. The manner for edge extraction is similar to that as described in FIG. 2, and will not be detailed any more.

In some implementations, the edge extracting part 210 may represent a first set of edges extracted from the first set of images 411 in a first set of edge maps 421 corresponding to the first set of images 411. Similarly, the edge extracting part 210 may represent a second set of edges extracted from the second set of images 412 in a second set of edge maps 422 corresponding to the second set of images 412.

Edge 3D Reconstruction based on VO Technology

One (e.g., the first set of images 411) of the two sets of images 411 and 412 may be considered as reference images. The first set of edge maps 421 corresponding to the reference images 411 may be provided to the depth determining part 230. The depth determining part 230 may reconstruct the first set of edges in a 3D space by determining the depths of the extracted first set of edges. Similar to the manner for edge 3D reconstruction as described in FIG. 2, the depth determining part 230 may use for example edge-based VO technology to perform 3D reconstruction of the first set of edges, where the depth of each edge pixel in the first set of edges is represented as a Gaussian distribution (namely, mean and variance of depth values). Different from the edge 3D reconstruction as described in FIG. 2, since the stereo camera can provide scale information based on disparity, introduction of the inertia measurement data is optional during the 3D reconstruction of the first set of edges. In this way, the depth determining part 230 may generate a first set of depth maps 441 corresponding to the first set of edge maps 421 and indicating respective depth of the first set of edges.

Edge 3D Reconstruction based on Stereo Matching

In some implementations, the first set of edge maps 421 and the second set of edge maps 422 may be provided together to the stereo matching part 430. The stereo matching part 430 may perform stereo matching for the first set of edge maps 421 and the second set of edge maps 422 to generate a second set of depth maps 442 for correcting the first set of depth images 441.

The principle of the stereo matching according to implementations of the subject matter described herein is to generate, by finding a correspondence between each pair of images captured by the calibrated stereo camera, a disparity map describing disparity information between the two images according to the principle of triangulation. The disparity map and the depth map may be convertible to each other. As stated above, the depth of each edge pixel may be represented as a Gaussian distribution (namely, mean and variance of depth values). Assume that the depth of a certain edge pixel is d and the variance is a, a stereo disparity value u associated with the edge pixel may be determined as: u=Bfd, where B represents a distance between optical centers of the first camera and the second camera, and f represents a focal distance of the stereo camera (the focal distance of the first camera is usually the same as the focal distance of the second camera). Similarly, a disparity variance associated with the edge pixel is σᵤ=Bfσ. The stereo matching process will be further described in more detail as below.

As stated above, the first set of images 411 are a plurality of continuous frames in the video captured by the first camera in the stereo camera, and the second set of images 412 are a plurality of continuous frames in the video captured by the second camera in the stereo camera. Without loss of generality, assume that the first set of images 411 include a frame (called a “third frame” herein) captured by the first camera, and the second set of images 412 include a frame (called a “fourth frame” herein) captured by the second camera corresponding to the third frame. The first set of edge maps 421 generated by the edge extracting part 210 may include an edge maps (called a “third edge map” herein) corresponding to the third frame, and the second set of edge maps 422 may include an edge map (called a “fourth edge map” herein) corresponding to the fourth frame. The first set of depth maps 441 determined by the depth determining part 230 may include a depth map (called a “third depth map”) corresponding to the third edge map.

In some implementations, the stereo matching part 430 may perform stereo matching for the third and fourth edge maps to generate a disparity map describing disparity information between these two. The disparity map may be converted into a depth map corresponding thereto (called a “fourth depth map” herein) to correct the third depth map. During execution of the stereo matching for the first edge map and the fourth edge map, the third depth map corresponding to the third edge map may be used to constrain the scope of stereo search in the stereo matching. The third depth map may be converted into a disparity map corresponding thereto according to the relationship between the disparity map and the depth map. For example, regarding an edge pixel with a depth d and a variance 6 in the third depth map, the stereo matching part 430 may search the fourth edge map for a matched edge pixel only in a range [u−2σᵤ, u+2σᵤ] along the epipolar line. Regarding an edge pixel with a relatively small variance, the search scope of the stereo matching is significantly reduced, thereby significantly improving the efficiency of stereo matching. For example, the edge matching criterions may be similar to those as described in FIG. 2, and will not be detailed any more here.

In this manner, the stereo matching part 430 can generate a set of disparity maps describing respective disparity information between the first set of edge maps 421 and the second set of edge maps 422 by performing stereo matching on them. The set of disparity maps may be further converted into the second set of depth maps 442.

### Depth Fusion

The first set of depth maps 441 generated by the depth determining part 230 and the second set of depth maps 442 generated by the stereo matching part 430 may be provided to the depth fusion part 450. In some implementations, the depth fusion part 450 may fuse the second set of depth maps 442 and the first set of depth maps 441 based on the EKF algorithm to generate the third set of depth maps 443. During execution of the EKF algorithm, the second set of depth maps 442 generated by the stereo matching part 430 may serve as observation variables to correct the first set of depth maps 441 generated by the depth determining part 230.

### Object Identification

The third set of depth maps 443 may be provided to the object identifying part 250. The object identifying part 250 may identify, based on the third set of depth maps 443, at least one edge belonging to the thin object. The object identifying part 250 may output the detection result 104 based on the identified edges belonging to the thin object. The manner for identifying the thin object is similar to that as described with respect to FIG. 2 and will not be detailed any more here.

### Example Process

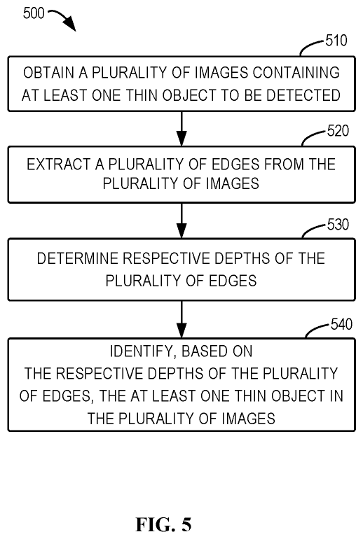

FIG. 5 illustrates a flow chart of a process for detecting a thin object according to some implementations of the subject matter described herein. The process 500 may be implemented by the computing device 100, for example, implemented at the image processing module 122 in the memory 120 of the computing device 100. At 510, the image processing module 122 obtains a plurality of images containing at least one thin object to be detected. At 520, the image processing module 122 extracts a plurality of edges from the plurality of images. At 530, the image processing module 122 determines respective depths of the plurality of edges. At 540, the image processing module 122 identifies, based on the respective depths of the plurality of edges, the at least one thin object in the plurality of images. The identified at least one thin object is represented by at least one of the plurality of edges.

In some implementations, a cross-sectional area of the at least one thin object is less than a first threshold and a length of the at least one thin object is greater than a second threshold. The first threshold is 0.2 square centimeters and the second threshold is 5 centimeters.

In some implementations, extracting the plurality of edges from the plurality of images comprises: generating a plurality of edge maps corresponding to the plurality of images respectively and identifying the plurality of edges. Determining the respective depths of the plurality of edges comprises: generating, based on the plurality of edges, a plurality of depth maps corresponding to the plurality of edge maps respectively and indicating the respective depths of the plurality of edges. Identifying the at least one thin object in the plurality of images comprises: identifying, based on the plurality of depth maps, at least one of the plurality of edges belonging to the at least one thin object.

In some implementations, extracting the plurality of edges from the plurality of images comprises: determining a likelihood that a pixel in the plurality of images belongs to the plurality of edges; and determining, at least based on the likelihood, whether the pixel belongs to the plurality of edges.

In some implementations, the plurality of images comprise a first frame from a video captured by a camera and a second frame subsequent to the first frame, and the plurality of edge maps comprise a first edge map corresponding to the first frame and a second edge map corresponding to the second frame. Generating the plurality of depth maps comprises: determining a first depth map corresponding to the first edge map; determining, at least based on the first and second edge maps, a movement of the camera corresponding to a change from the first frame to the second frame; and generating, at least based on the first depth map and the movement of the camera, a second depth map corresponding to the second edge map.

In some implementations, determining the movement of the camera comprises: performing first edge matching of the first edge map to the second edge map; and determining, based on a result of the first edge matching, the movement of the camera.

In some implementations, determining the movement of the camera further comprises: obtaining inertia measurement data associated with the camera; and determining, based on the first edge map, the second edge map and the inertia measurement data, the movement of the camera.

In some implementations, generating the second depth map comprises: generating, based on the first depth map and the movement of the camera, an intermediate depth map corresponding to the second edge map; performing, based on the movement of the camera, second edge matching of the second edge map to the first edge map; and generating, based on the intermediate depth map and a result of the second edge matching, the second depth map.

In some implementations, the plurality of image are captured by a stereo camera, the stereo camera comprises at least first and second cameras, and the plurality of images comprise at least a first set of images captured by the first camera and a second set of images captured by the second camera. Extracting the plurality of edges from the plurality of images comprises: extracting a first set of edges from the first set of images and a second set of edges from the second set of images. Determining the respective depths of the plurality of edges comprises: determining respective depths of the first set of edges; performing stereo matching for the first set of edges and the second set of edges; and updating, based on a result of the stereo matching, the respective depths of the first set of edges. Identifying the at least one thin object in the plurality of images comprises: identifying, based on the updated respective depths, the at least one thin object in the plurality of images.

### Example Implementations

Some example implementations of the subject matter described herein are listed below.

In one aspect, the subject matter described herein provides an apparatus. The apparatus comprises a processing unit and a memory coupled to the processing unit and storing instructions for execution by the processing unit. The instructions, when executed by the processing unit, cause the apparatus to perform acts including: obtaining a plurality of images containing at least one thin object to be detected; extracting a plurality of edges from the plurality of images; determining respective depths of the plurality of edges; and identifying the at least one thin object in the plurality of images based on the respective depths of the plurality of edges, the at least one identified thin object being represented by at least one of the plurality of edges.

In some implementations, a cross-sectional area of the at least one thin object is less than a first threshold and a length of the at least one thin object is greater than a second threshold. The first threshold is 0.2 square centimeters and the second threshold is 5 centimeters.

In some implementations, extracting the plurality of edges from the plurality of images comprises: generating a plurality of edge maps that correspond to the plurality of images and identify the plurality of edges, respectively. Determining the respective depths of the plurality of edges comprises: generating, based on the plurality of edge maps, a plurality of depth maps that correspond to the plurality of edge maps and indicate the respective depths of the plurality of edges, respectively. Identifying the at least one thin object in the plurality of images comprises: identifying, based on the plurality of depth maps, the at least one of the plurality of edges belonging to the at least one thin object.

In some implementations, extracting the plurality of edges from the plurality of images comprises: determining a likelihood that a pixel in the plurality of images belongs to the plurality of edges; and determining, at least based on the likelihood, whether the pixel belongs to the plurality of edges.

In some implementations, the plurality of images comprise a first frame from a video captured by a camera and a second frame subsequent to the first frame, and the plurality of edge maps include a first edge map corresponding to the first frame and a second edge map corresponding to the second frame. Generating the plurality of depth maps comprises: determining a first depth map corresponding to the first edge map; determining, at least based on the first and second edge maps, a movement of the camera corresponding to a change from the first frame to the second frame; and generating, at least based on the first depth map and the movement of the camera, a second depth map corresponding to the second edge map.

In some implementations, determining the movement of the camera comprises: performing first edge matching of the first edge map to the second edge map; and determining the movement of the camera based on a result of the first edge matching.

In some implementations, determining the movement of the camera further comprises: obtaining inertia measurement data associated with the camera; and determining the movement of the camera based on the first edge map, the second edge map and the inertia measurement data.

In some implementations, generating the second depth map comprises: generating, based on the first depth map and the movement of the camera, an intermediate depth map corresponding to the second edge map; performing second edge matching of the second edge map to the first edge map based on the movement of the camera; and generating the second depth map based on the intermediate depth map and a result of the second edge matching.

In some implementations, the plurality of image are captured by a stereo camera, the stereo camera including at least first and second cameras, the plurality of images including at least a first set of images captured by the first camera and a second set of images captured by the second camera. Extracting the plurality of edges from the plurality of images comprises: extracting a first set of edges from the first set of images and a second set of edges from the second set of images. Determining the respective depths of the plurality of edges comprises: determining respective depths of the first set of edges; performing stereo matching for the first and second sets of edges; and updating the respective depths of the first set of edges based on a result of the stereo matching. Identifying the at least one thin object in the plurality of images comprises: identifying the at least one thin object in the plurality of images based on the updated respective depths.

In another aspect, the subject matter described herein provides a method. The method comprises: obtaining a plurality of images containing at least one thin object to be detected; extracting a plurality of edges from the plurality of images; determining respective depths of the plurality of edges; and identifying the at least one thin object in the plurality of images based on the respective depths of the plurality of edges, the at least one identified thin object being represented by at least one of the plurality of edges.

In some implementations, a cross-sectional area of the at least one thin object is less than a first threshold and a length of the at least one thin object is greater than a second threshold. The first threshold is 0.2 square centimeters and the second threshold is 5 centimeters.

In some implementations, extracting the plurality of edges from the plurality of images comprises: generating a plurality of edge maps that correspond to the plurality of images and identify the plurality of edges, respectively. Determining the respective depths of the plurality of edges comprises: generating, based on the plurality of edge maps, a plurality of depth maps that correspond to the plurality of edge maps and indicate the respective depths of the plurality of edges, respectively. Identifying the at least one thin object in the plurality of images comprises: identifying, based on the plurality of depth maps, the at least one of the plurality of edges belonging to the at least one thin object.

In some implementations, extracting the plurality of edges from the plurality of images comprises: determining a likelihood that a pixel in the plurality of images belongs to the plurality of edges; and determining, at least based on the likelihood, whether the pixel belongs to the plurality of edges.

In some implementations, the plurality of images include a first frame from a video captured by a camera and a second frame subsequent to the first frame, and the plurality of edge maps include a first edge map corresponding to the first frame and a second edge map corresponding to the second frame. Generating the plurality of depth maps comprises: determining a first depth map corresponding to the first edge map; determining, at least based on the first and second edge maps, a movement of the camera corresponding to a change from the first frame to the second frame; and generating, at least based on the first depth map and the movement of the camera, a second depth map corresponding to the second edge map.

In some implementations, determining the movement of the camera comprises: performing first edge matching of the first edge map to the second edge map; and determining the movement of the camera based on a result of the first edge matching.

In some implementations, determining the movement of the camera further comprises: obtaining inertia measurement data associated with the camera; and determining the movement of the camera based on the first edge map, the second edge map and the inertia measurement data.

In some implementations, generating the second depth map comprises: generating, based on the first depth map and the movement of the camera, an intermediate depth map corresponding to the second edge map; performing second edge matching of the second edge map to the first edge map based on the movement of the camera; and generating the second depth map based on the intermediate depth map and a result of the second edge matching.

In some implementations, the plurality of image are captured by a stereo camera including at least first and second cameras, and the plurality of images include at least a first set of images captured by the first camera and a second set of images captured by the second camera. Extracting the plurality of edges from the plurality of images comprises: extracting a first set of edges from the first set of images and a second set of edges from the second set of images. Determining the respective depths of the plurality of edges comprises: determining respective depths of the first set of edges; performing stereo matching for the first and second sets of edges; and updating the respective depths of the first set of edges based on a result of the stereo matching. Identifying the at least one thin object in the plurality of images comprises: identifying, the at least one thin object in the plurality of images based on the updated respective depths.

In a further aspect, the subject matter described herein provides a computer program product tangibly stored on a non-transient computer storage medium and including machine executable instructions. The machine executable instructions, when executed by an apparatus, cause the apparatus to perform the method in the above aspect.

In a further aspect, the subject matter described herein provides a computer readable medium having machine executable instructions stored thereon. The machine executable instructions, when executed by an apparatus, cause the apparatus to perform the method in the above aspect.

The functionally described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard

Products (ASSPs), System-on-a-chip systems (SOCs), Complex Programmable Logic Devices (CPLDs), and the like.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard drive, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are described in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Conversely, various features that are described in the context of a single implementation may also be implemented in a plurality of implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. An apparatus, comprising:
a processing unit;
a memory coupled to the processing unit and storing instructions for execution by the processing unit, the instructions, when executed by the processing unit, causing the apparatus to perform acts including:
obtaining a plurality of images containing at least one thin object to be detected;
extracting a plurality of edges from the plurality of images;
determining respective depths of the plurality of edges; and
identifying the at least one thin object in the plurality of images based on the respective depths of the plurality of edges, the at least one identified thin object being represented by at least one of the plurality of edges.

2. The apparatus according to claim 1, wherein a cross-sectional area of the at least one thin object is less than a first threshold and a length of the at least one thin object is greater than a second threshold, and wherein the first threshold is 0.2 square centimeters and the second threshold is 5 centimeters.

3. The apparatus according to claim 1, wherein
extracting the plurality of edges from the plurality of images comprises:
generating a plurality of edge maps that correspond to the plurality of images and identify the plurality of edges, respectively;
determining the respective depths of the plurality of edges comprises:
generating, based on the plurality of edge maps, a plurality of depth maps that correspond to the plurality of edge maps and indicate the respective depths of the plurality of edges, respectively; and
identifying the at least one thin object in the plurality of images comprises:
identifying, based on the plurality of depth maps, the at least one of the plurality of edges belonging to the at least one thin object.

4. The apparatus according to claim 1, wherein extracting the plurality of edges from the plurality of images comprises:
determining a likelihood that a pixel in the plurality of images belongs to the plurality of edges; and
determining, at least based on the likelihood, whether the pixel belongs to the plurality of edges.

5. The apparatus according to claim 3, wherein the plurality of images include a first frame from a video captured by a camera and a second frame subsequent to the first frame, and the plurality of edge maps include a first edge map corresponding to the first frame and a second edge map corresponding to the second frame, generating the plurality of depth maps comprises:
determining a first depth map corresponding to the first edge map;
determining, at least based on the first and second edge maps, a movement of the camera corresponding to a change from the first frame to the second frame; and
generating, at least based on the first depth map and the movement of the camera, a second depth map corresponding to the second edge map.

6. The apparatus according to claim 5, wherein determining the movement of the camera comprises:
performing first edge matching of the first edge map to the second edge map; and
determining the movement of the camera based on a result of the first edge matching.

7. The apparatus according to claim 5, wherein determining the movement of the camera further comprises:
obtaining inertia measurement data associated with the camera; and
determining the movement of the camera based on the first edge map, the second edge map and the inertia measurement data.

8. The apparatus according to claim 5, wherein generating the second depth map comprises:
generating, based on the first depth map and the movement of the camera, an intermediate depth map corresponding to the second edge map;
performing second edge matching of the second edge map to the first edge map based on the movement of the camera; and
generating the second depth map based on the intermediate depth map and a result of the second edge matching.

9. The apparatus according to claim 1, wherein the plurality of image are captured by a stereo camera including at least first and second cameras, the plurality of images including at least a first set of images captured by the first camera and a second set of images captured by the second camera, and wherein
extracting the plurality of edges from the plurality of images comprises:
extracting a first set of edges from the first set of images and a second set of edges from the second set of images;
determining the respective depths of the plurality of edges comprises:
determining respective depths of the first set of edges;
performing stereo matching for the first and second sets of edges; and
updating the respective depths of the first set of edges based on a result of the stereo matching; and
identifying the at least one thin object in the plurality of images comprises:
identifying the at least one thin object in the plurality of images based on the updated respective depths.

10. A computer-implemented method, comprising:
obtaining a plurality of images containing at least one thin object to be detected;
extracting a plurality of edges from the plurality of images;
determining respective depths of the plurality of edges; and
identifying the at least one thin object in the plurality of images based on the respective depths of the plurality of edges, the at least one identified thin object being represented by at least one of the plurality of edges.

11. The method according to claim 10, wherein a cross-sectional area of the at least one thin object is less than a first threshold and a length of the at least one thin object is greater than a second threshold, and wherein the first threshold is 0.2 square centimeters and the second threshold is 5 centimeters.

12. The method according to claim 10, wherein
extracting the plurality of edges from the plurality of images comprises:
generating a plurality of edge maps that correspond to the plurality of images and identify the plurality of edges, respectively;
determining the respective depths of the plurality of edges comprises:
generating, based on the plurality of edge maps, a plurality of depth maps that correspond to the plurality of edge maps and indicate the respective depths of the plurality of edges, respectively; and
identifying the at least one thin object in the plurality of images comprises:
identifying, based on the plurality of depth maps, the at least one of the plurality of edges belonging to the at least one thin object.

13. The method according to claim 10, wherein extracting the plurality of edges from the plurality of images comprises:
determining a likelihood that a pixel in the plurality of images belongs to the plurality of edges; and
determining, at least based on the likelihood, whether the pixel belongs to the plurality of edges.

14. The method according to claim 12, wherein the plurality of images include a first frame from a video captured by a camera and a second frame subsequent to the first frame, and the plurality of edge maps include a first edge map corresponding to the first frame and a second edge map corresponding to the second frame, generating the plurality of depth maps comprises:
determining a first depth map corresponding to the first edge map;
determining, at least based on the first and second edge maps, a movement of the camera corresponding to a change from the first frame to the second frame; and
generating, at least based on the first depth map and the movement of the camera, a second depth map corresponding to the second edge map.

15. The method according to claim 14, wherein determining the movement of the camera comprises:
performing first edge matching of the first edge map to the second edge map; and
determining the movement of the camera based on a result of the first edge matching.
